(19) United States
(12) Patent Application Publication
(10) Pub. No.: US 2025/0392930 A1
(43) Pub. Date: Dec. 25, 2025

(54) COMMUNICATION TERMINAL DEVICE AND WIRELESS COMMUNICATION METHOD

(71) Applicant: JVCKENWOOD Corporation, Yokohama-shi (JP)

(72) Inventor: Motoshi Yoshimura, Yokohama-shi (JP)

(21) Appl. No.: 19/313,945

(22) Filed: Aug. 29, 2025

Related U.S. Application Data
(63) Continuation of application No. PCT/JP2024/005786, filed on Feb. 19, 2024.

(30) Foreign Application Priority Data
Mar. 2, 2023 (JP) 2023-031863

(51) Int. Cl. H04W 24/04

(52) U.S. Cl. CPC H04W 24/04

(57) ABSTRACT

A communication terminal device includes a first communication unit that performs information communication with a management device, a second communication unit that performs the information communication with another communication terminal device, a communication determination unit that determines whether or not the information communication performed by the first communication unit is possible, a role determination unit that determines a role of the own communication terminal device, a first communication control unit that controls the first communication unit, and a second communication control unit that controls the second communication unit. In a case where the information communication to be performed by the first communication unit is impossible, and also, in a case where the own communication terminal device is not a representative terminal, the second communication control unit transmits the information that is to be transmitted to the management device to the other communication terminal device. In a case where the information communication to be performed by the first communication unit is impossible, and also, in a case where the own communication terminal device is the representative terminal, the first communication control unit stores the information that is to be transmitted to the management device and the information that has been received from the other communication terminal device in the storage unit, and transmits the information stored in the storage unit to the management device when the information communication to be performed by the first communication unit becomes possible.

### CROSS-REFERENCE TO RELATED APPLICATIONS

This application is a Continuation of PCT International Application No. PCT/JP2024/005786 filed on Feb. 19, 2024 which claims the benefit of priority from Japanese Patent Application No. 2023-031863, filed on Mar. 2, 2023, the entire contents of both of which are incorporated herein by reference.

### BACKGROUND OF THE INVENTION

### 1. Field of the Invention

The present disclosure relates to a communication terminal device and a wireless communication method.

### 2. Description of the Related Art

A technology capable of managing activity information on a user who possesses a wireless communication terminal even in a case where the wireless communication terminal is not able to perform wireless communication with a wireless base station has been disclosed (for example, see Japanese Laid-open Patent Publication No. 2015-139120).

In the technology described in Japanese Laid-open Patent Publication No. 2015-139120, each of a plurality of wireless communication terminals temporarily stores the activity information, and transmits the temporarily stored activity information to a management server or the like in a case where it is determined that the wireless communication is able to be performed. In this case, the plurality of wireless communication terminals transmit the pieces of temporarily stored respective activity information all at once, so that a communication band is likely to be pressed.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A communication terminal device according to the present disclosure comprising: a first communication unit that performs information communication with a management device by using a first communication technique; a second communication unit that performs the information communication with another communication terminal device by using a second communication technique; a communication determination unit that determines whether or not the information communication to be performed by the first communication unit is possible; a role determination unit that determines whether or not a role of the own communication terminal device is a representative terminal;
a first communication control unit that controls the information communication performed by the first communication unit; and a second communication control unit that controls the information communication performed by the second communication unit, wherein the communication determination unit determines that the information communication is impossible in a case where the first communication unit receives pause information from the management device, the communication determination unit determines that the information communication is possible in a case where the first communication unit receives return information after having received the pause information from the management device, in a case where the communication determination unit determines that the information communication to be performed by the first communication unit is impossible, and also, in a case where the role determination unit determines that the own communication terminal device is not the representative terminal, the second communication control unit transmits information that is to be transmitted to the management device by using the first communication unit to the other communication terminal device by using the second communication unit, in a case where the communication determination unit determines that the information communication to be performed by the first communication unit is impossible, and also, in a case where the role determination unit determines that the own communication terminal device is the representative terminal, the first communication control unit stores, in a storage unit, the information that is to be transmitted to the management device by the own communication terminal device by using the first communication unit and the information that has been received from the other communication terminal device by the second communication unit, and in a case where the communication determination unit determines that the information communication to be performed by the first communication unit becomes possible, the first communication control unit transmits the information stored in the storage unit to the management device by using the first communication unit.

A wireless communication method according to the present disclosure comprising: a step of performing information communication with a management device by a first communication unit using a first communication technique; a step of performing the information communication with another communication terminal device by a second communication unit using a second communication technique; a step of determining whether or not the information communication performed by the first communication unit is possible; a step of determining whether or not a role of the own communication terminal device is a representative terminal; a step of controlling the information communication performed by the first communication unit; a step of controlling the information communication performed by the second communication unit; a step of determining that the information communication is impossible in a case where the first communication unit receives pause information from the management device; a step of determining that the information communication is possible in a case where the first communication unit receives return information after having received the pause information from the management device; a step of transmitting information that is to be transmitted to the management device by using the first communication unit to the other communication terminal device by using the second communication unit, in a case it is determined that the information communication to be performed by the first communication unit is impossible, and also, it is determined that the own communication terminal device is not the representative terminal; a step of storing, in a storage unit, the information that is to be transmitted to the management device by the own communication terminal device by using the first communication unit and the information that has been received from the other communication terminal device by the second communication unit in a case where it is determined that the information communication to be performed by the first communication unit is impossible, and also, in a case where it is determined that the own communication terminal device is the representative terminal; and a step of transmitting the information stored in the storage unit to the management device by using the first communication unit in a case where it is determined that the information communication to be performed by the first communication unit becomes possible.

### BRIEF DESCRIPTION OF THE DRAWINGS

FIG. 1 is a diagram illustrating an example of a configuration of a communication system according to a first embodiment;

FIG. 2 is a diagram for explaining an outline of a process performed in the communication system according to the first embodiment;

FIG. 3 is a block diagram illustrating an example of a configuration of a communication terminal device according to the first embodiment;

FIG. 4 is a diagram for explaining a communication failure according to the first embodiment;

FIG. 5 is a sequence diagram illustrating a communication method that is used in a time period during which a communication failure occurs in the communication system according to the first embodiment;

FIG. 6 is a flowchart illustrating a communication failure determination process according to the first embodiment;

FIG. 7 is a sequence diagram illustrating a communication method that is used after the communication failure occurring in the communication system according to the first embodiment has been resolved;

FIG. 8 is a diagram illustrating one example of a data structure of information according to the first embodiment;

FIG. 9 is a diagram illustrating one example of a data structure in which a plurality of pieces of information according to the first embodiment are aggregated;

FIG. 10 is a diagram for explaining a communication failure according to a second embodiment;

FIG. 11 is a sequence diagram illustrating a communication method that is used in a time period during which a communication failure occurs in the communication system according to the second embodiment;

FIG. 12 is a flowchart illustrating a communication failure determination process according to the second embodiment;

FIG. 13 is a sequence diagram illustrating a communication method that is used after the communication failure occurring in the communication system according to the second embodiment has been resolved;

FIG. 14 is a sequence diagram illustrating a communication method that is used in a time period during which a communication failure occurs in the communication system according to a third embodiment;

FIG. 15 is a sequence diagram illustrating a communication method that is used after the communication failure occurring in the communication system according to the third embodiment has been resolved;

FIG. 16 is a sequence diagram illustrating a communication method that is used in a time period during which a communication failure occurs in the communication system according to a fourth embodiment;

FIG. 17 is a flowchart illustrating transmission determination process performed on a short message according to the fourth embodiment;

FIG. 18 is a sequence diagram illustrating a communication method that is used after the communication failure occurring in the communication system according to the fourth embodiment has been resolved;

FIG. 19 is a diagram for explaining a communication failure according to a fifth embodiment;

FIG. 20 is a sequence diagram illustrating a communication method that is used while a relay repeater included in a communication system according to the fifth embodiment is in a pause mode;

FIG. 21 is a flowchart illustrating a pause determination process according to the fifth embodiment; and

FIG. 22 is a sequence diagram illustrating a communication method that is used after the relay repeater included in the communication system according to the fifth embodiment has been transitioned from the pause mode to a normal mode.

### DETAILED DESCRIPTION OF THE PREFERRED EMBODIMENTS

Hereinafter, preferred embodiments of the present disclosure will be explained in detail with reference to accompanying drawings. Furthermore, the present disclosure is not limited to the embodiments described below, and, in addition, in the embodiments described below, the same components are denoted by the same reference numerals and an overlapping description thereof will be omitted.

### First Embodiment

### Communication System

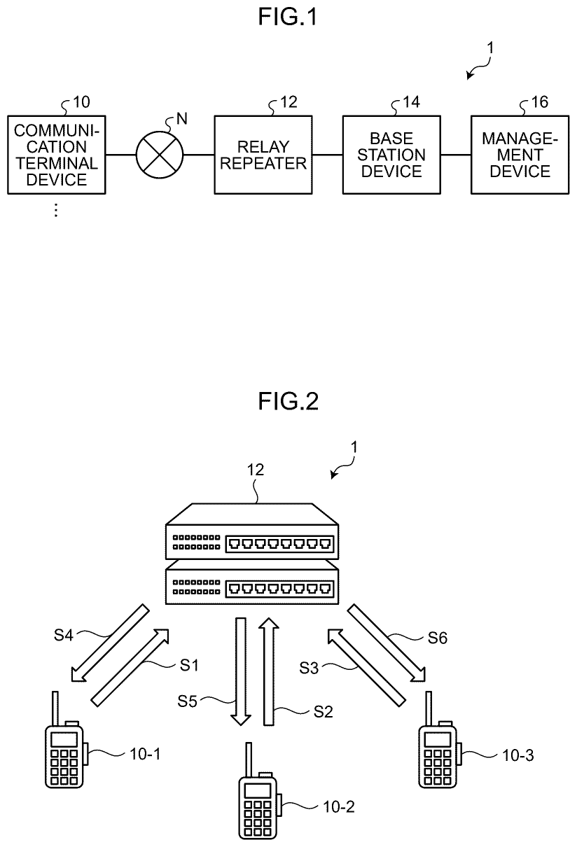

An example of a configuration of a communication system according to a first embodiment will be described with reference to FIG. 1. FIG. 1 is a diagram illustrating an example of a configuration of the communication system according to the first embodiment.

As illustrated in FIG. 1, a communication system 1 includes a plurality of communication terminal devices 10, a relay repeater 12, a base station device 14, and a management device 16. The plurality of communication terminal devices 10 and the relay repeater 12 are communicably connected via a network N.

The communication terminal device 10 is a communication device, such as a wireless device for business use or a smartphone. The communication terminal device 10 performs wireless communication with the relay repeater 12 via the network N. The communication terminal device 10 performs wireless communication with the base station device 14 via the relay repeater 12.

The relay repeater 12 is a communication device that relays the wireless communication between the communication terminal device 10 and the base station device 14. The relay repeater 12 performs wireless communication with the communication terminal device 10 via the network N. The relay repeater 12 performs wireless communication with the base station device 14. Furthermore, the relay repeater 12 and the base station device 14 may be connected via the network N.

The base station device 14 is a communication device that performs wireless communication with the communication terminal device 10 via the relay repeater 12.

The management device 16 is a device that manages communication performed in the communication system 1. The management device 16 manages communication performed in, for example, the base station device 14.

### Outline of Communication System

An outline of a process performed in the communication system according to the first embodiment will be described with reference to FIG. 2. FIG. 2 is a diagram illustrating the outline of the process performed in the communication system according to the first embodiment.

FIG. 2 schematically illustrates the communication performed between the communication terminal device 10 and the relay repeater 12. As illustrated in FIG. 2, it is assumed that the communication system 1 includes a communication terminal device 10-1, a communication terminal device 10-2, a communication terminal device 10-3, and the relay repeater 12. In the following, the description will be made on the assumption that the communication system 1 includes the three communication terminal devices 10 indicated by the communication terminal device 10-1, the communication terminal device 10-2, and the communication terminal device 10-3, but the present disclosure is not limited to this example.

The communication terminal device 10-1 transmits an uplink signal S1 to the relay repeater 12. The relay repeater 12 transmits various kinds of information included in the uplink signal S1 to the base station device 14. The relay repeater 12 transmits a downlink signal S4 to the communication terminal device 10-1. The downlink signal S4 includes the various kinds of information that have been transmitted by the base station device 14.

The communication terminal device 10-2 transmits an uplink signal S2 to the relay repeater 12. The relay repeater 12 transmits various kinds of information that are included in the uplink signal S2 to the base station device 14. The relay repeater 12 transmits a downlink signal S5 to the communication terminal device 10-2. The downlink signal S5 includes the various kinds of information that have been transmitted by the base station device 14.

The communication terminal device 10-3 transmits an uplink signal S3 to the relay repeater 12. The relay repeater 12 transmits various kinds of information included in the uplink signal S3 to the base station device 14. The relay repeater 12 transmits a downlink signal S6 to the communication terminal device 10-3. The downlink signal S6 includes the various kinds of information that have been transmitted by the base station device 14.

As illustrated in FIG. 2, the communication terminal device 10-1 to the communication terminal device 10-3 are able to perform wireless communication with the base station device 14 via the relay repeater 12. In the present embodiment, in a case where the communication terminal device 10-1 to the communication terminal device 10-3 are not able to communicate with the relay repeater 12, the pieces of information that are to be transmitted to the relay repeater 12 are aggregated to one of the communication terminal device 10-1 to the communication terminal device 10-3 functioning as a representative terminal. Then, the representative terminal transmits the aggregated pieces of information to the relay repeater 12 all at once when the communication terminal device 10-1 to the communication terminal device 10-3 are able to communicate with the relay repeater 12.

### Communication Terminal Device

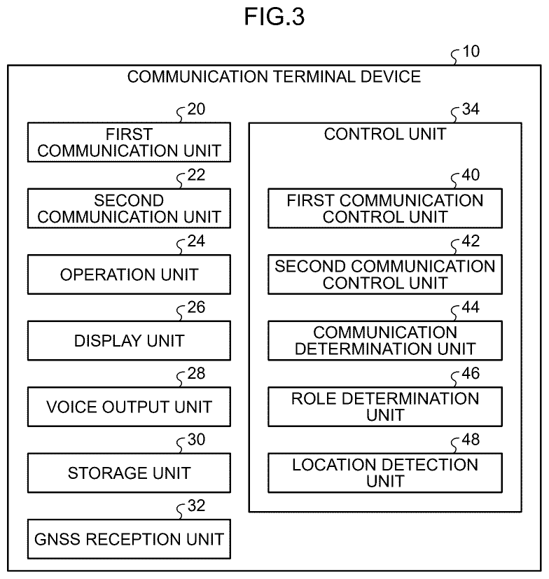

An example of a configuration of the communication terminal device according to the first embodiment will be described with reference to FIG. 3. FIG. 3 is a block diagram illustrating an example of the configuration of the communication terminal device according to the first embodiment.

As illustrated in FIG. 3, the communication terminal device 10 includes a first communication unit 20, a second communication unit 22, an operation unit 24, a display unit 26, a voice output unit 28, a storage unit 30, a Global Navigation Satellite System (GNSS) reception unit 32, and a control unit 34.

The first communication unit 20 communicates with the relay repeater 12 via the network N. The technique of the communication performed by the first communication unit 20 is referred to as a first communication technique. An example of the first communication technique includes digital radio communication for business use, such as Association of Public safety Communications Officials international Project 25 (APCO-P25) and NXDN (registered trademark). The first communication technique may also be communication performed by using the Internet, a mobile phone network, or the like.

The second communication unit 22 communicates with the other communication terminal device 10 by using a near field wireless communication technique. The technique of the communication performed by the second communication unit 22 is referred to as a second communication technique. An example of the near field wireless communication technique includes communication performed by, for example, Wi-Fi (registered trademark) and Bluetooth (registered trademark), but the embodiment is not limited to this example. The second communication unit 22 transmits, for example, location information, a short message, or the like to the other communication terminal device 10.

The operation unit 24 receives various kinds of input operations performed on the communication terminal device 10. The operation unit 24 outputs an input signal in accordance with the received input operation to the control unit 34. The operation unit 24 includes, for example, a touch panel, a button, a switch, a microphone, a Push to Talk (PTT) button, and the like.

The display unit 26 displays various kinds of video images. The display unit 26 is a display including, for example, a liquid crystal display (LCD), an organic Electro-Luminescence (EL) display, or the like.

The voice output unit 28 outputs various kinds of voice. The voice output unit 28 outputs, for example, a voice of a user who possesses the other communication terminal device 10. The voice output unit 28 is a speaker.

The storage unit 30 stores therein various kinds of information. The storage unit 30 stores therein information, such as content of an arithmetic operation performed by the control unit 34, a program, and the like. The storage unit 30 includes at least one of, for example, a main storage device, such as a random access memory (RAM) or a read only memory (ROM), and an external storage device, such as a hard disk drive (HDD).

The storage unit 30 includes information that indicates, for example, whether or not the own device is the representative terminal from among the plurality of communication terminal devices 10.

The GNSS reception unit 32 is configured by a GNSS receiver or the like that receives a GNSS signal sent from GNSS satellites. The GNSS reception unit 32 outputs the received GNSS signal to a location detection unit 48.

The control unit 34 controls each of the units included in the communication terminal device 10. The control unit 34 includes, for example, an information processing apparatus, such as a central processing unit (CPU) or a micro processing unit (MPU), and a storage device, such as a RAM or a ROM. The control unit 34 may be implemented by, for example, an integrated circuit, such as an application specific integrated circuit (ASIC) or a field programmable gate array (FPGA). The control unit 34 may be implemented by a combination of hardware and software.

The control unit 34 includes a first communication control unit 40, a second communication control unit 42, a communication determination unit 44, a role determination unit 46, and the location detection unit 48.

The first communication control unit 40 causes the first communication unit 20 to control information communication to be performed by using the first communication technique. The first communication control unit 40 causes the first communication unit 20 to set a predetermined channel and to communicate with the relay repeater 12 by using the first communication technique.

The second communication control unit 42 causes the second communication unit 22 to control information communication to be performed by using the second communication technique. The second communication control unit 42 causes the second communication unit 22 to communicate with the other communication terminal device 10 by using the second communication technique. In a case where, for example, the communication terminal device 10 is the representative terminal, the second communication control unit 42 receives the location information and a short message related to and output from the other communication terminal device 10 received by the second communication unit 22, and causes the storage unit 30 to store the received data.

The communication determination unit 44 determines whether or not information communication to be performed by the first communication unit 20 is possible. Descriptions of the communication determination unit 44 in detail will be described later.

The role determination unit 46 determines whether or not the communication terminal device 10 is the representative terminal from among the plurality of communication terminal devices 10. In a case where the information indicating that, for example, the communication terminal device 10 is the representative terminal is stored in the storage unit 30, the role determination unit 46 determines that the own device is the representative terminal. The role determination unit 46 may search for, for example, the other communication terminal device 10 that is communicable with the second communication unit 22, may generate a group of the communication terminal devices 10 that are communicable with the second communication unit 22, and may determine that the communication terminal device 10 having the smallest number of an identifier that identifies the communication terminal devices 10 included in the group is the representative terminal.

The location detection unit 48 detects the location of the communication terminal device 10. The location detection unit 48 detects the location of the communication terminal device on the basis of the GNSS signal received by the GNSS reception unit 32. The location detection unit 48 calculates, for example, the global coordinates of the communication terminal device 10 on the basis of the GNSS signal.

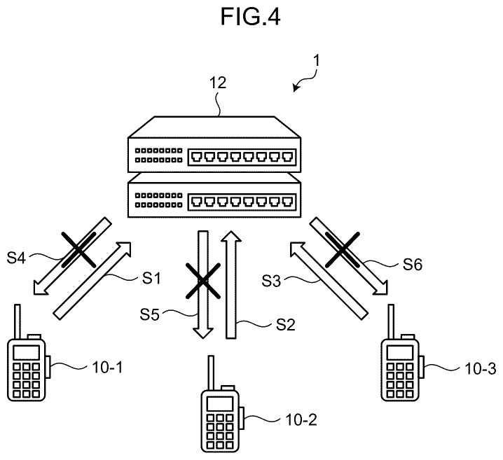

A communication failure according to the first embodiment will be described with reference to FIG. 4. FIG. 4 is a diagram for explaining the communication failure according to the first embodiment.

As illustrated in FIG. 4, it is assumed that a communication failure has occurred in a path for the downlink signal in the communication system 1. In this case, the communication terminal device 10-1 to the communication terminal device 10-3 are not able to receive the downlink signal S4 to the downlink signal S6, respectively, that have been sent from the relay repeater 12. When each of the communication terminal device 10-1 to the communication terminal device 10-3 receives, for example, an idle signal transmitted by the relay repeater, each of the communication terminal device 10-1 to the communication terminal device 10-3 detects a current location, and transmits the location information that is related to the detected location to the relay repeater 12. In other words, in a time period during which a communication failure occurs in the path for the downlink signal in the communication system 1, the relay repeater 12 is not able to receive the location information from each of the communication terminal device 10-1 to the communication terminal device 10-3. As a result of this, in a time period during which a communication failure occurs in the path for the downlink signal in the communication system 1, the management device 16 is not able to manage the location information on each of the communication terminal device 10-1 to the communication terminal device 10-3.

### Communication Method

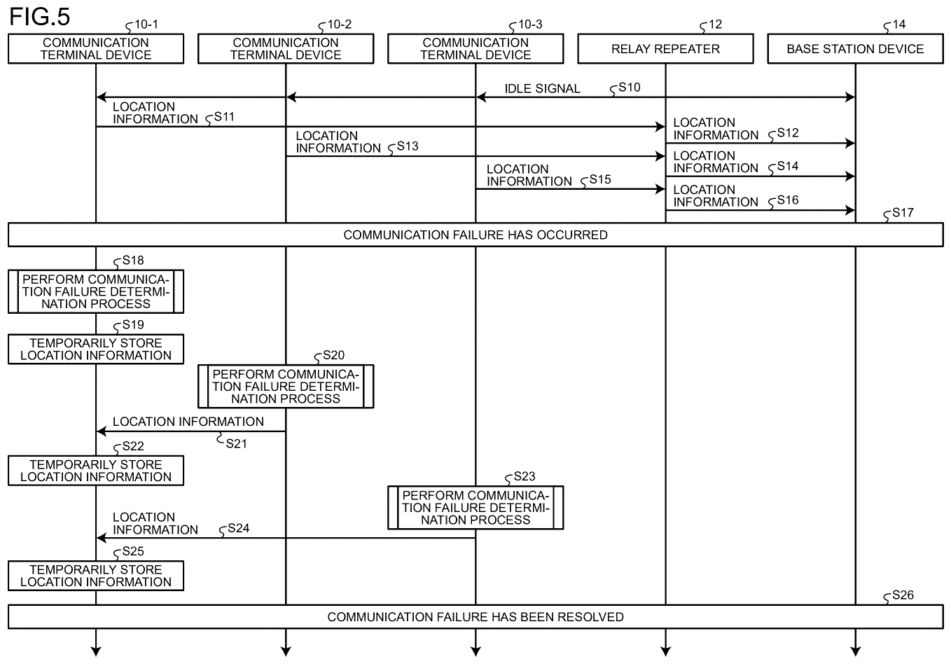

A communication method that is used in the communication system according to the first embodiment will be described with reference to FIG. 5. FIG. 5 is a sequence diagram illustrating the communication method that is used in a time period during which a communication failure occurs in the communication system according to the first embodiment.

FIG. 5 illustrates the processes that are performed in a time period between a point at which a communication failure occurs in the communication path for the downlink signal in the communication system 1 and a point at which the occurred communication failure has been resolved. In the following, a description will be made on the assumption that the communication terminal device 10-1 is the representative terminal that is determined in advance from among the communication terminal device 10-1, the communication terminal device 10-2, and the communication terminal device 10-3. In addition, it is assumed that each of the communication terminal device 10-1, the communication terminal device 10-2, and the communication terminal device 10-3 is located at a distance in which the communication terminal device 10-1, the communication terminal device 10-2, and the communication terminal device 10-3 are communicable with the second communication unit 22 by using the second communication technique.

The relay repeater 12 periodically transmits an idle signal (report signal) to the communication terminal device 10-1, the communication terminal device 10-2, the communication terminal device 10-3, and the base station device 14 before the communication failure occurs (Step S10).

When the first communication control unit 40 included in the communication terminal device 10-1 receives the idle signal from the relay repeater 12, the first communication control unit 40 causes the first communication unit 20 to transmit the location information that has been detected by the location detection unit 48 and that indicates the current location to the relay repeater 12 by using the first communication technique (Step S11). The relay repeater 12 transmits the location information received from the communication terminal device 10-1 to the base station device 14 (Step S12).

When the first communication control unit 40 included in the communication terminal device 10-2 receives the idle signal from the relay repeater 12, the first communication control unit 40 included in the communication terminal device 10-2 causes the first communication unit 20 to transmit location information that has been detected by the location detection unit 48 and that indicates the current location to the relay repeater 12 by using the first communication technique (Step S13). The relay repeater 12 transmits the location information received from the communication terminal device 10-2 to the base station device 14 (Step S14).

When the first communication control unit 40 included in the communication terminal device 10-3 receives the idle signal from the relay repeater 12, the first communication control unit 40 included in the communication terminal device 10-3 causes the first communication unit 20 to transmit the location information that has been detected by the location detection unit 48 and that indicates the current location to the relay repeater 12 by using the first communication technique (Step S15). The relay repeater 12 transmits the location information received from the communication terminal device 10-3 to the base station device 14 (Step S16).

Step S10 to Step S16 are the processes that are periodically performed in a time period during which the communication system 1 is in operation.

Here, it is assumed that a communication failure has occurred due to an occurrence of a jamming beam or the like in the communication path for the downlink signal in the communication system 1 (Step S17).

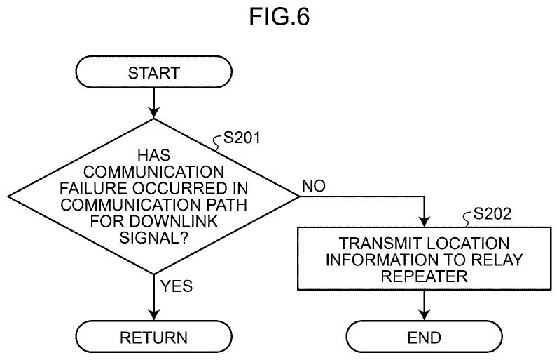

The control unit 34 included in the communication terminal device 10-1 performs a communication failure determination process (Step S18). FIG. 6 is a flowchart illustrating the communication failure determination process according to the first embodiment. The communication determination unit 44 included in the communication terminal device 10-1 determines whether or not a communication failure has occurred in the communication path for the downlink signal (Step S201). Specifically, the communication determination unit 44 included in the communication terminal device 10-1 determines that the communication failure has occurred in the communication path for the downlink signal in a case where, for example, the first communication unit 20 included in the communication terminal device 10-1 is not able to receive the idle signal output from the relay repeater 12 in a predetermined time period or longer. For example, in a case where the first communication unit 20 included in the communication terminal device 10-1 receives a jamming beam, the communication determination unit 44 included in the communication terminal device 10-1 may determine that a communication failure has occurred in the communication path for the downlink signal. In a case where it is determined that a communication failure has occurred in the communication path for the downlink signal (Yes at Step S201), the process proceeds to Step S19. In a case where it is determined that a communication failure has not occurred in the communication path for the downlink signal (No at Step S201), the process proceeds to Step S202. In a case where it is determined to be No at Step S201, when the first communication control unit 40 included in the communication terminal device 10-1 receives an idle signal from the relay repeater 12, the first communication control unit 40 included in the communication terminal device 10-1 causes the first communication unit 20 to transmit the location information that has been detected by the location detection unit 48 and that indicates the current location to the relay repeater 12 by using the first communication technique (Step S202). Then, the first communication control unit 40 included in the communication terminal device 10-1 ends the process.

In a case where the first communication control unit 40 included in the communication terminal device 10-1 is not able to receive an idle signal from the relay repeater 12, the first communication control unit 40 included in the communication terminal device 10-1 temporarily stores the location information that has been detected by the location detection unit 48 and that indicates the current location in the storage unit 30 (Step S19).

The control unit 34 included in the communication terminal device 10-2 performs the communication failure determination process (Step S20). The communication failure determination process is almost the same as that illustrated in FIG. 6, and therefore, descriptions thereof will be omitted, but, in a case where it is determined that a communication failure has occurred in the communication path for the downlink signal (Yes at Step S201), the process proceeds to Step S21.

The second communication control unit 42 included in the communication terminal device 10-2 causes the second communication unit 22 to transmit location information that has been detected by the location detection unit 48 and that indicates the current location to the communication terminal device 10-1 by using the second communication technique (Step S21). The second communication control unit 42 included in the communication terminal device 10-1 temporarily stores the location information that indicates the current location of the communication terminal device 10-2 that has been received from the communication terminal device 10-2 by the second communication unit 22 in the storage unit 30 (Step S22).

The control unit 34 included in the communication terminal device 10-3 performs the communication failure determination process (Step S23). The communication failure determination process is the same as that illustrated in FIG. 6, and therefore, descriptions thereof will be omitted, but, in a case where it is determined that a communication failure has occurred in the communication path for the downlink signal (Yes at Step S201), the process proceeds to Step S24.

The second communication control unit 42 included in the communication terminal device 10-3 causes the second communication unit 22 to transmit the location information that has been detected by the location detection unit 48 and that indicates the current location to the communication terminal device 10-1 by using the second communication technique (Step S24). The second communication control unit 42 included in the communication terminal device 10-1 temporarily stores the location information that indicates the current location of the communication terminal device 10-3 and that has been received from the communication terminal device 10-2 by the second communication unit 22 in the storage unit 30 (Step S25).

Here, it is assumed that the communication failure that occurs in the communication path for the downlink signal in the communication system 1 has been resolved (Step S26). Then, the process illustrated in FIG. 5 has been completed.

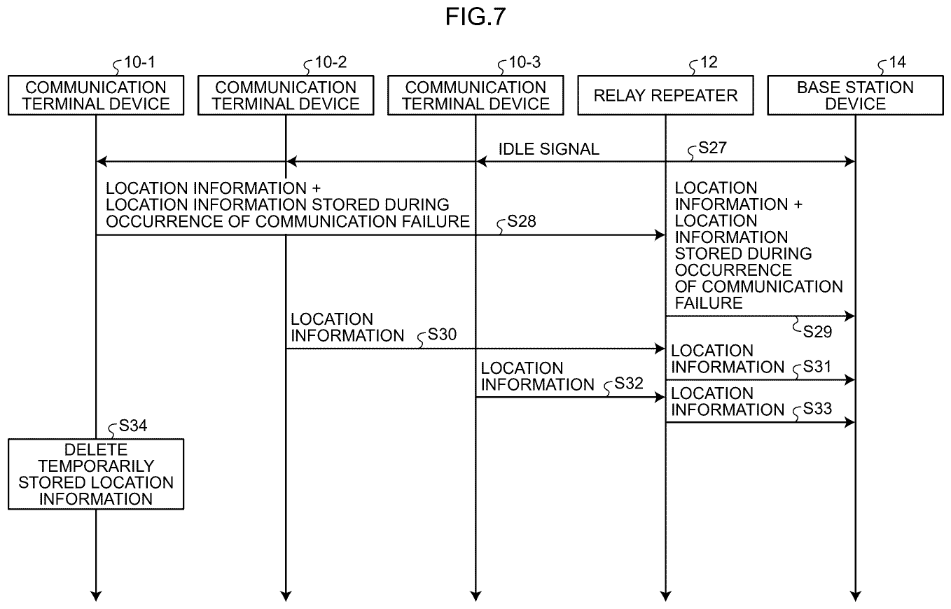

A communication method that is used in the communication system according to the first embodiment will be described with reference to FIG. 7. FIG. 7 is a sequence diagram illustrating a communication method that is used after the communication failure occurring in the communication system according to the first embodiment has been resolved.

When the communication failure occurring in the communication system 1 has been resolved, the communication terminal device 10-1, the communication terminal device 10-2, the communication terminal device 10-3, and the base station device 14 again periodically receives an idle signal from the relay repeater 12 (Step S27).

When the first communication control unit 40 included in the communication terminal device 10-1 receives the idle signal from the relay repeater 12, the first communication control unit 40 included in the communication terminal device 10-1 causes the first communication unit 20 to aggregate the location information that has been detected by the location detection unit 48 and that indicates the current location, the location information that is related to the communication terminal device 10-1 and that is stored in the storage unit 30 during the occurrence of the communication failure, and the pieces of location information that have been received from the communication terminal device 10-2 and the communication terminal device 10-3, and to transmit the aggregated location information to the relay repeater 12 by using the first communication technique (Step S28). Furthermore, after the process at Step S28, the communication terminal device 10-1 may notify, by using the second communication technique, the communication terminal device 10-2 and the communication terminal device 10-3 that the aggregated location information has been transmitted to the relay repeater 12.

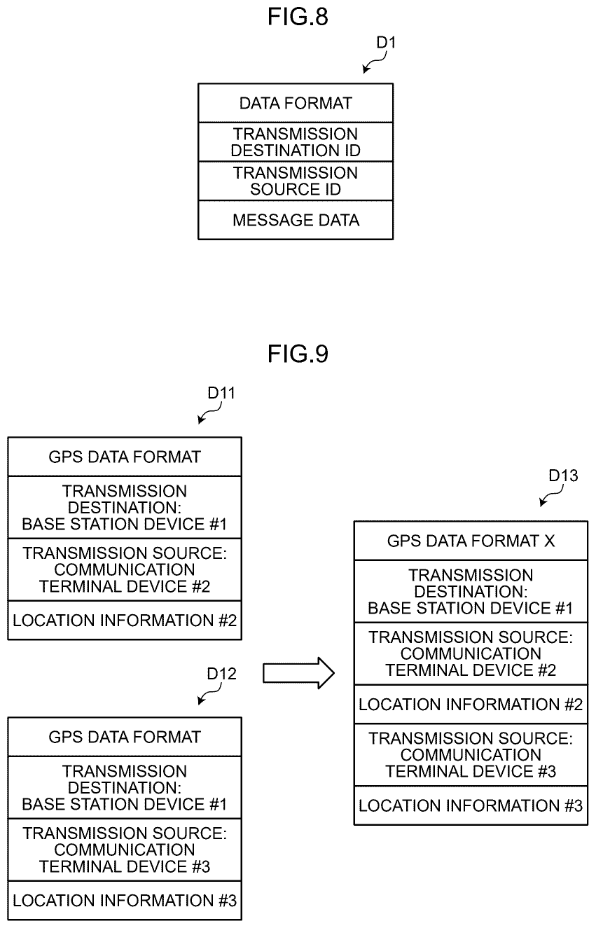

In the following, a data structure of the information that is transmitted by the communication terminal device according to the first embodiment to the relay repeater will be described with reference to FIG. 8 and FIG. 9. FIG. 8 is a diagram illustrating one example of the data structure of the information according to the first embodiment. FIG. 9 is a diagram illustrating one example of the data structure in which a plurality of pieces of information according to the first embodiment are aggregated.

As illustrated in FIG. 8, a data structure D1 includes various kinds of information, such as a “data format”, a “transmission destination ID”, a “transmission source ID”, and “message data”. The “data format” indicates a type of the information. The “data format” indicates the location information (GNSS data, GPS data, etc.), message data, or the like. Furthermore, the type of the “data format” is not limited in the present invention. The “transmission destination ID” indicates identification information for identifying the transmission destination of the information. The “transmission source ID” indicates the identification information for identifying the transmission source of the information. A “short message” indicates the content of the message in a case where the transmission source transmits the short message.

A method of aggregating pieces of information according to the first embodiment will be described with reference to FIG. 9. A data structure D11 includes information, such as a “GPS Data Format”, a “transmission destination: base station device #1”, a “transmission source: communication terminal device #2”, and “location information #2”. A data structure D12 includes information, such as a “GPS Data Format”, the “transmission destination: base station device #1”, a “transmission source: communication terminal device #3”, and “location information #3”. For example, the “GPS Data Format” indicates that the data structure is the location information. For example, the “transmission destination: base station device #1” indicates that the transmission destination is the base station device #1. For example, the “transmission source: communication terminal device #2” indicates that the transmission source is a communication terminal device #2. For example, the “location information #2” indicates the latitude longitude information in which the communication terminal device #2 is located. The latitude longitude information may include a time stamp (time information). The control unit 34 included in the communication terminal device 10-1 aggregates the data structure D11 and the data structure D12, and generates a data structure D13.

The data structure D13 includes information, such as a “GPS Data Format X”, the “transmission destination: base station device #1”, a “transmission source: communication terminal device #2”, the “location information #2”, the “transmission source: communication terminal device #3”, and the “location information #3”. The “GPS Data Format X” indicates that the data structure is the aggregated location information. When the data structure D13, the data structure D11, and the data structure D12 are compared, in the data structure D13, one item of the “Data Format” and one item of the “transmission destination: base station device #1” are omitted. In other words, by aggregating the data structure D11 and the data structure D12, it is possible to reduce an amount of data.

A description will be given here by referring back to FIG. 7. The relay repeater 12 transmits, to the base station device 14, the location information that indicates the current location of the communication terminal device 10-1 and that has been received from the communication terminal device 10-1, and the pieces of location information on the communication terminal device 10-1 in which a communication failure currently occurs, the communication terminal device 10-2, and the communication terminal device 10-3 (Step S29).

The processes to be performed at Step S30 to Step S33 are the same as the processes performed at Step S13 to Step S16, respectively, illustrated in FIG. 5, and therefore, descriptions thereof will be omitted.

The control unit 34 included in the communication terminal device 10-1 deletes the pieces of location information on the communication terminal device 10-1 to the communication terminal device 10-3 stored in the storage unit 30 during the occurrence of the communication failure (Step S34). Then, the communication system 1 repeatedly performs the process at Step S10 to Step S16 that have been performed before the communication failure illustrated in FIG. 5 occurs.

As described above, in the first embodiment, in a case where a communication failure occurs in the communication path for the downlink signal, the pieces of location information on the respective communication terminal devices indicated in the time period during which the communication failure occurs are aggregated into the representative terminal. Then, in the first embodiment, after the communication failure has been resolved, the representative terminal transmits, all at once, the pieces of location information on the respective communication terminal devices indicated during the occurrence of the communication failure to the relay repeater. In other words, after the communication failure has been resolved, the communication terminal devices other than the representative terminal do not transmit the location information that is not able to be transmitted to the relay device during the time period of the occurrence of the communication failure. As a result of this, in the first embodiment, it is possible to prevent a strain of the communication line, such as an occurrence of congestion of the transmission signal generated as a result of each of the communication terminal devices attempting to retransmit the location information that is not able to be transmitted during the occurrence of the communication failure to the relay repeater all at once. In addition, it is possible to prevent the location information on each of the communication terminal devices from missing during the time period during which the communication failure occurs in the communication path for the downlink signal.

### Second Embodiment

A second embodiment will be described. An example of the configuration of each of the communication system and the communication terminal device according to the second embodiment is the same as that of the first embodiment, and therefore, descriptions thereof will be omitted.

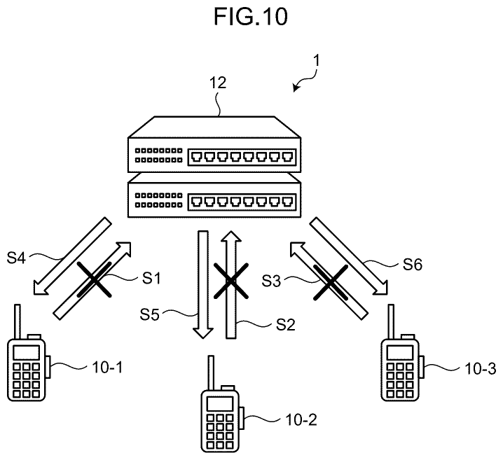

A communication failure according to the second embodiment will be described with reference to FIG. 10. FIG. 10 is a diagram illustrating the communication failure according to the second embodiment.

As illustrated in FIG. 10, it is assumed that a communication failure has occurred in a path for the uplink signal in the communication system. In this case, the communication terminal device 10-1 to the communication terminal device 10-3 are not able to transmit the uplink signal S1 to the uplink signal S3, respectively, to the relay repeater 12. In other words, in a time period during which the communication failure occurs in the path for the uplink signal in the communication system 1, the relay repeater 12 is not able to receive the location information from each of the communication terminal device 10-1 to the communication terminal device 10-3. As a result of this, in a time period during which the communication failure occurs in the path for the uplink signal in the communication system 1, the management device 16 is not able to manage the location information on each of the communication terminal device 10-1 to the communication terminal device 10-3.

### Communication Method

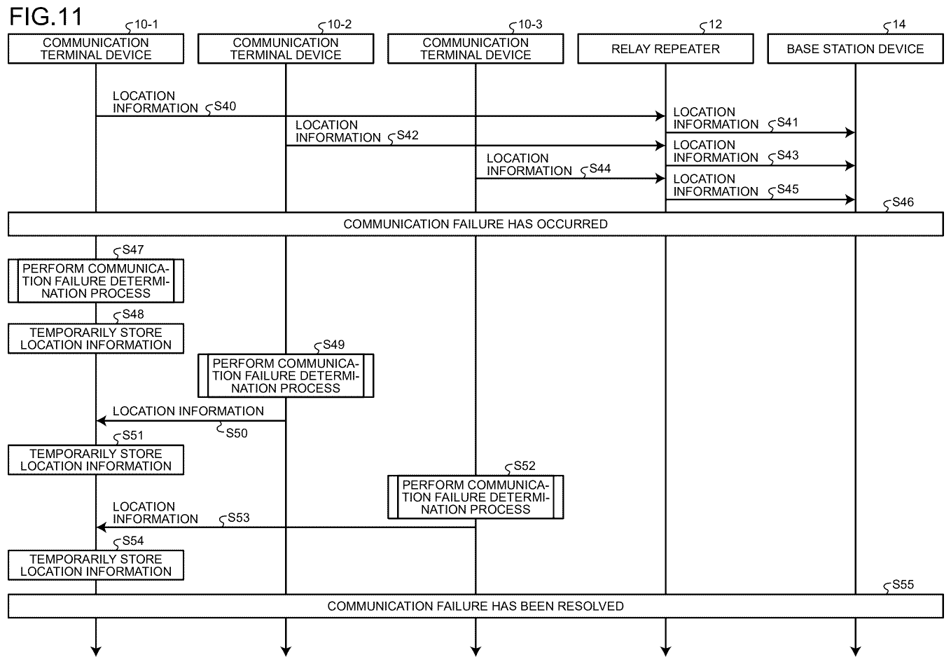

A communication method that is used in the communication system according to the second embodiment will be described with reference to FIG. 11. FIG. 11 is a sequence diagram illustrating a communication method that is used in a time period during which a communication failure occurs in the communication system according to the second embodiment.

The processes to be performed at Step S40 to Step S45 are the same as the processes performed at Step S11 to Step S16, respectively, illustrated in FIG. 5, and therefore, descriptions thereof will be omitted.

The processes performed at Step S40 to Step S4 are periodically performed in a time period during which the communication system 1 is in operation.

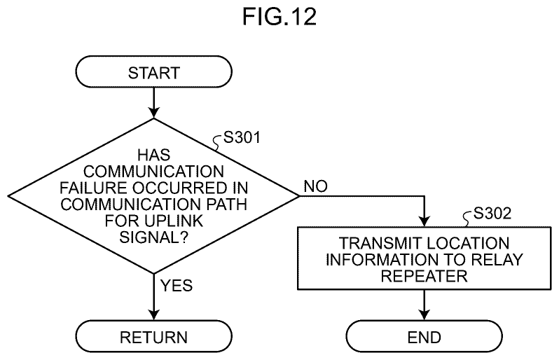

Here, it is assumed that a communication failure has occurred due to an occurrence of a jamming beam or the like in the communication path for the uplink signal in the communication system 1 (Step S46).
the control unit 34 included in the communication terminal device 10-1 performs a communication failure determination process (Step S47). FIG. 12 is a flowchart illustrating the communication failure determination process according to the second embodiment. The communication determination unit 44 included in the communication terminal device 10-1 determines whether or not a communication failure has occurred in the communication path for the uplink signal (Step S301). Specifically, the communication determination unit 44 included in the communication terminal device 10-1 may have a function of detecting whether or not a jamming beam occurs in the communication path for the uplink signal by using, for example, the first communication unit 20. In this case, the communication determination unit 44 included in the communication terminal device 10-1 determines that a communication failure occurs in the communication path for the uplink signal, on the basis of the detection result that is obtained by the first communication unit 20 and that indicates that a jamming beam occurs in the communication path for the uplink signal. The communication determination unit 44 included in the communication terminal device 10-1 determines that a communication failure has occurred in the communication path for the uplink signal in a case where, for example, the first communication unit 20 transmits a communication failure confirmation signal to the relay repeater 12 and is not able to receive a response (Ack) to the transmitted communication failure confirmation signal. In a case where it is determined that a communication failure has occurred in the communication path for the uplink signal (Yes at Step S301), the process proceeds to Step S48. In a case where it is determined that a communication failure does not occur in the communication path for the uplink signal (No at Step S301), the process proceeds to Step S302. In a case where it is determined to be No at Step S301, the first communication control unit 40 included in the communication terminal device 10-1 causes the first communication unit 20 to transmit the location information that indicates the current location and that has been detected by the location detection unit 48 to the relay repeater 12 by using the first communication technique (Step S302). Then, the first communication control unit 40 included in the communication terminal device 10-1 ends the process.

In a case where a communication failure occurs in the communication path for the uplink signal, the first communication control unit 40 included in the communication terminal device 10-1 temporarily stores the location information that indicates the current location and that has been detected by the location detection unit 48 in the storage unit 30 (Step S48).

The control unit 34 included in the communication terminal device 10-2 performs the communication failure determination process (Step S49). The communication failure determination process is the same as that illustrated in FIG. 12, and therefore, descriptions thereof will be omitted, but, in a case where it is determined that a communication failure has occurred in the communication path for the uplink signal (Yes at Step S301), the process proceeds to Step S50 illustrated in FIG. 11.

The second communication control unit 42 included in the communication terminal device 10-2 causes the second communication unit 22 to transmit the location information that has been detected by the location detection unit 48 and that indicates the current location to the communication terminal device 10-1 by using the second communication technique (Step S50). The second communication control unit 42 included in the communication terminal device 10-1 temporarily stores the location information that indicates the current location of the communication terminal device 10-2 and that has been received from the communication terminal device 10-2 by the second communication unit 22 in the storage unit 30 (Step S51).

The control unit 34 included in the communication terminal device 10-3 performs the communication failure determination process (Step S52). The communication failure determination process is the same as that illustrated in FIG. 12, and therefore, descriptions thereof will be omitted, but, in a case where it is determined that a communication failure has occurred in the communication path for the uplink signal (Yes at Step S301), the process proceeds to Step S53 illustrated in FIG. 11.

The second communication control unit 42 included in the communication terminal device 10-3 causes the second communication unit 22 to transmit the location information that has been detected by the location detection unit 48 and that indicates the current location to the communication terminal device 10-1 by using the second communication technique (Step S53). The second communication control unit 42 included in the communication terminal device 10-1 temporarily stores the location information that indicates the current location of the communication terminal device 10-3 and that has been received from the communication terminal device 10-3 by the second communication unit 22 in the storage unit 30 (Step S54).

Here, it is assumed that the communication failure that occurs in the communication path for the uplink signal in the communication system 1 has been resolved (Step S55). And then, the processes illustrated in FIG. 11 have been completed.

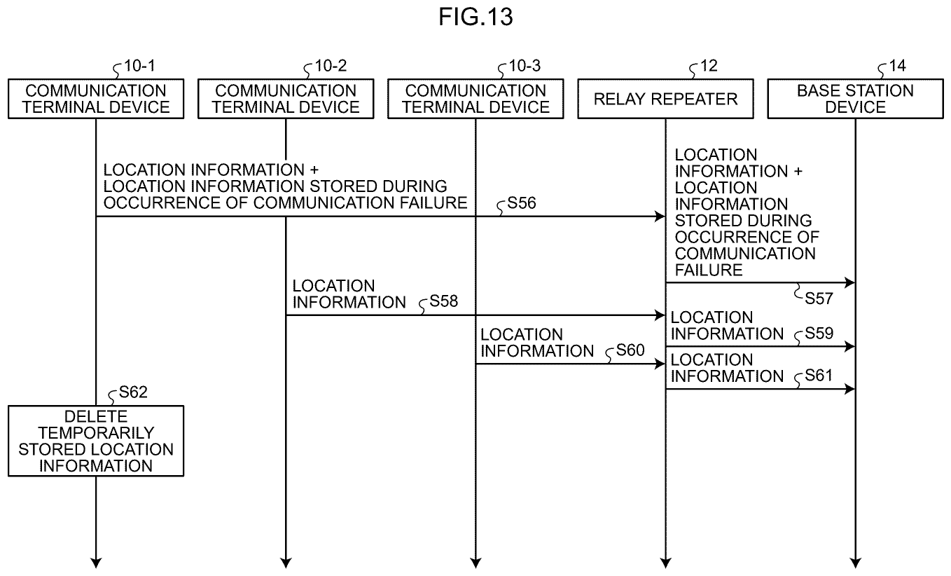

A communication method that is used in the communication system according to the second embodiment will be described with reference to FIG. 13. FIG. 13 is a sequence diagram illustrating a communication method that is used after the communication failure occurring in the communication system according to the second embodiment has been resolved.

The processes to be performed at Step S56 to Step S62 are the same as the processes performed at Step S28 to Step S34, respectively, illustrated in FIG. 7, and therefore, descriptions thereof will be omitted. Then, after the process at Step S62, the communication system 1 repeatedly performs the process at Step S40 to Step S45 that have been performed before the communication failure illustrated in FIG. 11 occurs.

As described above, in the second embodiment, in a case where a communication failure occurs in the communication path for the uplink signal, the pieces of location information on the respective communication terminal devices indicated in the time period during which the communication failure occurs are aggregated into the representative terminal. Then, in the second embodiment, after the communication failure has been resolved, the representative terminal transmits, all at once, the pieces of location information on the respective communication terminal devices indicated during the occurrence of the communication failure to the relay repeater. In other words, after the communication failure has been resolved, the communication terminal devices other than the representative terminal do not transmit the location information that is not able to be transmitted to the relay device during the time period of the occurrence of the communication failure. As a result of this, in the second embodiment, it is possible to prevent a strain of the communication line, such as an occurrence of congestion of the transmission signal generated as a result of each of the communication terminal devices attempting to retransmit the location information that is not able to be transmitted during the occurrence of the communication failure to the relay repeater all at once. In addition, it is possible to prevent the location information on each of the communication terminal devices from missing during the time period during which the communication failure occurs in the communication path for the uplink signal.

### Third Embodiment

A third embodiment will be described. An example of the configuration of each of the communication system and the communication terminal device according to the third embodiment is the same as that of the first embodiment, and therefore, descriptions thereof will be omitted.

In the third embodiment, as illustrated in FIG. 4, in a case where a communication failure has occurred in the communication path for the downlink signal, and in a case where each of the communication terminal device 10-1 to the communication terminal device 10-3 transmits a short message to the relay repeater 12, a process of aggregating the short messages into the representative terminal is performed.

### Communication Method

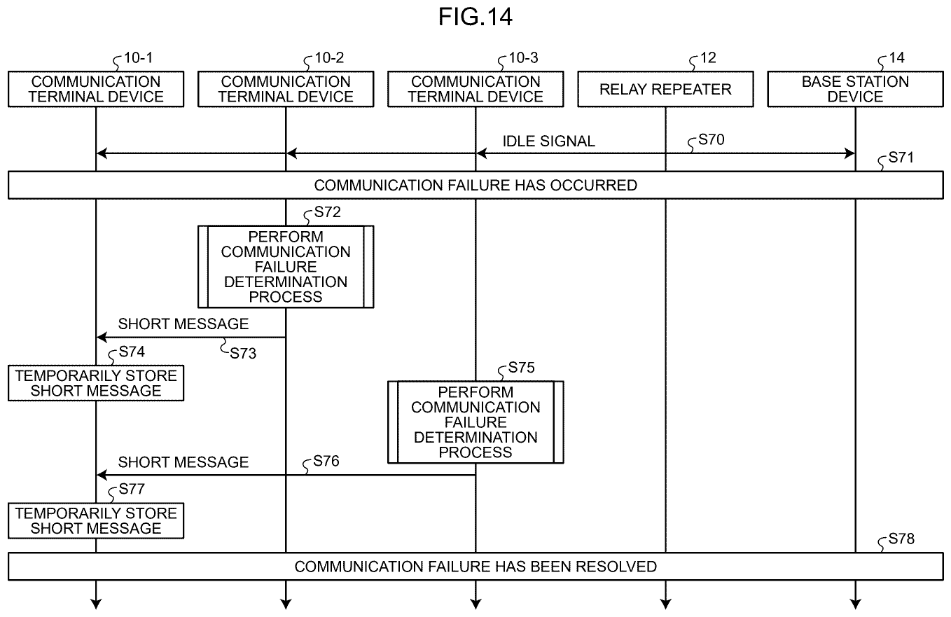

A communication method that is used in the communication system according to the third embodiment will be described with reference to FIG. 14. FIG. 14 is a sequence diagram illustrating a communication method that is used in a time period during which a communication failure occurs in the communication system according to the third embodiment.

The process to be performed at Step S70 is the same as that performed at Step S10 illustrated in FIG. 5, and therefore, a description thereof will be omitted.

Here, it is assumed that a communication failure has occurred due to an occurrence of a jamming beam or the like in the communication path for the downlink signal in the communication system 1 (Step S71).

The process to be performed at Step S72 is the same as that performed at Step S20 illustrated in FIG. 5, and therefore, a description thereof will be omitted.

The second communication control unit 42 included in the communication terminal device 10-2 causes the second communication unit 22 to transmit the short message that has been input to the operation unit 24 to the communication terminal device 10-1 by using the second communication technique (Step S73). Moreover, the short message is not limited to the character string that has been input by using the operation unit 24, but the short message may be input by being selected from template messages that have been prepared in advance. The second communication control unit 42 included in the communication terminal device 10-1 temporarily stores the short message received from the communication terminal device 10-2 by the second communication unit 22 in the storage unit 30 (Step S74).

The process to be performed at Step S75 is the same as that performed at Step S23 illustrated in FIG. 5, and therefore, a description thereof will be omitted.

The second communication control unit 42 included in the communication terminal device 10-3 causes the second communication unit 22 to transmit the short message that has been input to the operation unit 24 to the communication terminal device 10-1 by using the second communication technique (Step S76). The second communication control unit 42 included in the communication terminal device 10-1 temporarily stores the short message received from the communication terminal device 10-3 by the second communication unit 22 in the storage unit 30 (Step S77).

Here, it is assumed that the communication failure that has occurred in the communication path for the downlink signal in the communication system 1 has been resolved (Step S78). And then, the processes illustrated in FIG. 14 have been completed.

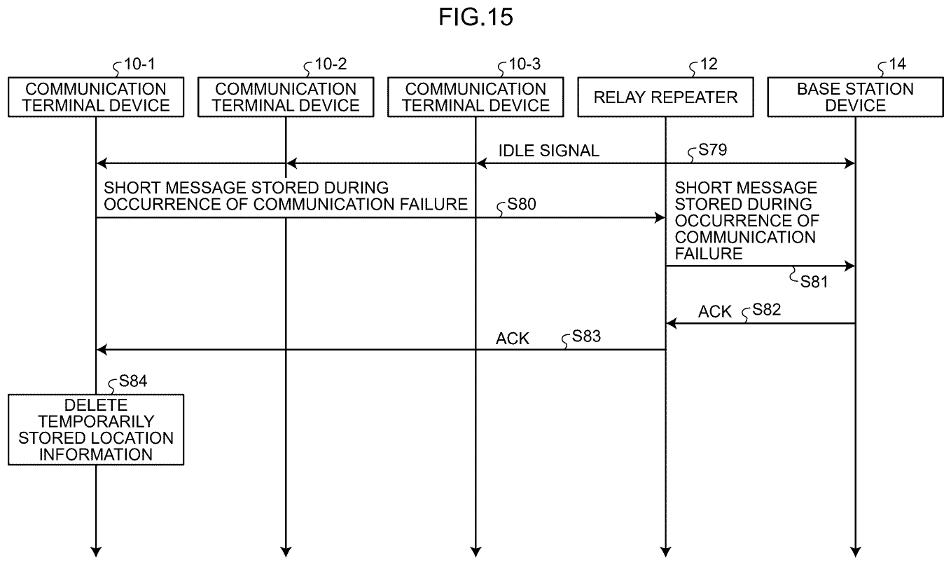

A communication method that is used in the communication system according to the third embodiment will be described with reference to FIG. 15. FIG. 15 is a sequence diagram illustrating a communication method that is used after the communication failure occurring in the communication system according to the third embodiment has been resolved.

The process to be performed at Step S79 is the same as that performed at Step S70 illustrated in FIG. 14, and therefore, a description thereof will be omitted.

When the first communication control unit 40 included in the communication terminal device 10-1 receives an idle signal from the relay repeater 12, the first communication control unit 40 included in the communication terminal device 10-1 causes the first communication unit 20 to aggregate the short messages that are received from the communication terminal device 10-2 and the communication terminal device 10-3 during the occurrence of the communication failure and that are stored in the storage unit 30 and to transmit the aggregated short message to the relay repeater 12 by using the first communication technique (Step S80). The relay repeater 12 transmits the short message received from the communication terminal device 10-1 to the base station device 14 (Step S81).

The base station device 14 transmits an Ack with respect to the received short message to the relay repeater 12 (Step S82). The relay repeater 12 transmits the Ack received from the base station device 14 to the communication terminal device 10-1 (Step S83).

The control unit 34 included in the communication terminal device 10-1 deletes the short messages stored in the storage unit 30 during the occurrence of the communication failure (Step S84). And then, the control unit 34 included in the communication terminal device 10-1 ends the process.

As described above, in the third embodiment, in a case where a communication failure has occurred in the communication path for the downlink signal, the short messages that have been transmitted by the respective communication terminal devices during the occurrence of the communication failure are aggregated in the representative terminal. Then, in the third embodiment, after the communication failure has been resolved, the short messages received from the respective communication terminal devices during the occurrence of the communication failure are transmitted to the relay repeater by the representative terminal all at once. In other words, after the communication failure has been resolved, the communication terminal devices other than the representative terminal do not transmit the respective short messages that are not able to be transmitted to the relay device during the occurrence of the communication failure. As a result of this, in the third embodiment, it is possible to prevent a strain of the communication line, such as an occurrence of congestion of the transmission signal generated as a result of each of the communication terminal devices attempting to retransmit the corresponding short message that is not able to be transmitted during the occurrence of the communication failure to the relay repeater all at once.

### Fourth Embodiment

A fourth embodiment will be described. An example of a configuration of each of a communication system and a communication terminal device according to the fourth embodiment is the same as that described above in the first embodiment, and therefore, descriptions thereof will be omitted.

In the fourth embodiment, as illustrated in FIG. 10, in a case where a communication failure has occurred in the communication path for the uplink signal, and in a case where each of the communication terminal device 10-1 to the communication terminal device 10-3 transmits a short message to the relay repeater 12, a process of aggregating the short messages into the representative terminal is performed.

### Communication Method

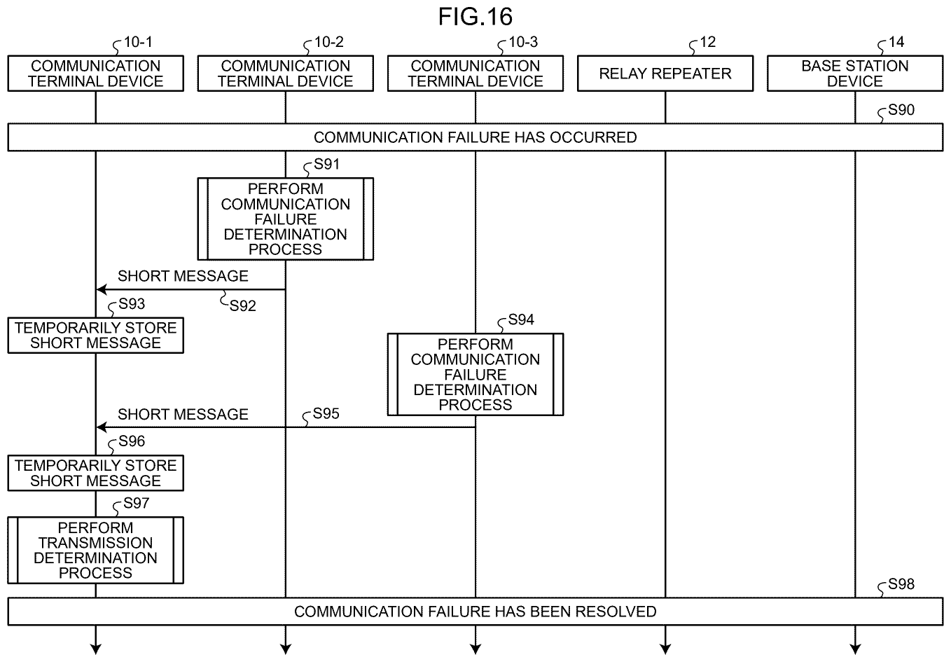

A communication method that is used in the communication system according to the fourth embodiment will be described with reference to FIG. 16. FIG. 16 is a sequence diagram illustrating a communication method that is used in a time period during which a communication failure occurs in the communication system according to a fourth embodiment.

It is assumed that a communication failure has occurred due to an occurrence of a jamming beam or the like in the communication path for the uplink signal in the communication system 1 (Step S90).

The process to be performed at Step S91 is the same as that performed at Step S49 illustrated in FIG. 11, and therefore, a description thereof will be omitted.

The processes to be performed at Step S92 and Step S93 are the same as those performed at Step S73 and Step S74, respectively, illustrated in FIG. 14, and therefore, descriptions thereof will be omitted.

The process to be performed at Step S94 is the same as that performed at Step S52 illustrated in FIG. 11, and therefore, a description thereof will be omitted.

The processes to be performed at Step S95 and Step S96 are the same as those performed at Step S76 and Step S77, respectively, illustrated in FIG. 14, and therefore, descriptions thereof will be omitted.

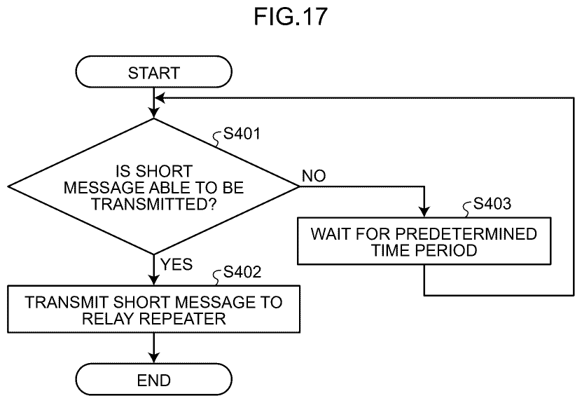

The control unit 34 included in the communication terminal device 10-1 performs a transmission determination process on the short message (Step S97). FIG. 17 is a flowchart illustrating transmission determination process performed on a short message according to the fourth embodiment. The communication determination unit 44 included in the communication terminal device 10-1 determines whether or not a short message is able to be transmitted to the relay repeater 12 (Step S401). Specifically, in a case where the communication failure that has occurred in the communication path for the uplink signal has been resolved, the communication determination unit 44 included in the communication terminal device 10-1 determines that the short message is able to be transmitted to the relay repeater 12. In a case where it is determined that the short message is able to be transmitted (Yes at Step S401), the process proceeds to Step S402. In a case where it is not determined that the short message is not able to be transmitted (No at Step S401), the process proceeds to Step S403. In a case where it is determined to be Yes at Step S401, the first communication control unit 40 included in the communication terminal device 10-1 causes the first communication unit 20 to transmit the short message to the relay repeater 12 (Step S402). And then, the first communication control unit 40 included in the communication terminal device 10-1 ends the process. In a case where it is determined to be No at Step S401, the control unit 34 included in the communication terminal device 10-1 waits for a predetermined time period (Step S403). And then, the process proceeds to Step S401.

A description will be given here by referring back to FIG. 16. Here, it is assumed that the communication failure that has occurred in the communication path for the uplink signal in the communication system 1 has been resolved (Step S98). And then, the processes illustrated in FIG. 16 have been completed.

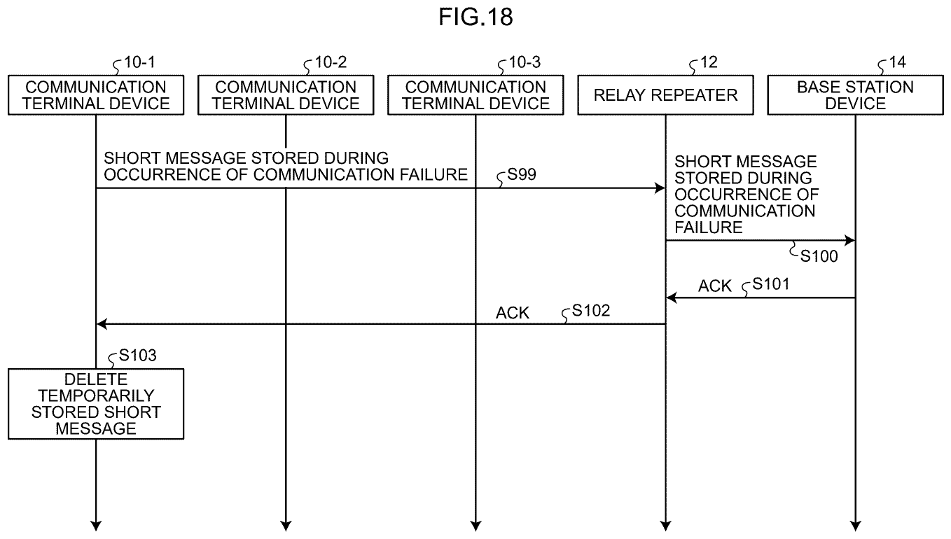

A communication method that is used in the communication system according to the fourth embodiment will be described with reference to FIG. 18. FIG. 18 is a sequence diagram illustrating a communication method that is used after the communication failure occurring in the communication system according to the fourth embodiment has been resolved.

It is determined that the short message is able to be transmitted to the relay repeater 12 at Step S401 illustrated in FIG. 17 as a result of the communication failure having been resolved at Step S98 illustrated in FIG. 16 (Yes at Step S401), so that the process at Step S402 is performed, and then the short message that is temporarily stored in the storage unit 30 included in the communication terminal device 10-1 and that is not transmitted during the occurrence of the communication failure is transmitted to the relay repeater 12 (Step S99). The processes to be performed at Step S99 to Step S103 are the same as those performed at Step S80 to Step S84, respectively, illustrated in FIG. 15, and therefore, descriptions thereof will be omitted.

As described above, in the fourth embodiment, in a case where a communication failure has occurred in the communication path for the uplink signal, the short messages that have been transmitted by the respective communication terminal devices during the occurrence of the communication failure are aggregated in the representative terminal. Then, in the fourth embodiment, after the communication failure has been resolved, the short messages received from the respective communication terminal devices during the occurrence of the communication failure are transmitted to the relay repeater by the representative terminal all at once. In other words, after the communication failure has been resolved, the communication terminal devices other than the representative terminal do not transmit the respective short messages that are not able to be transmitted to the relay device during the occurrence of the communication failure. As a result of this, in the fourth embodiment, it is possible to prevent a strain of the communication line, such as an occurrence of congestion of the transmission signal generated as a result of each of the communication terminal devices attempting to retransmit the corresponding short message that is not able to be transmitted during the occurrence of the communication failure to the relay repeater all at once.

### Fifth Embodiment

A fifth embodiment will be described. An example of a configuration of each of a communication system and a communication terminal device according to the fifth embodiment are the same as that described above in the first embodiment, and therefore, a description thereof will be omitted.

### Communication Failure

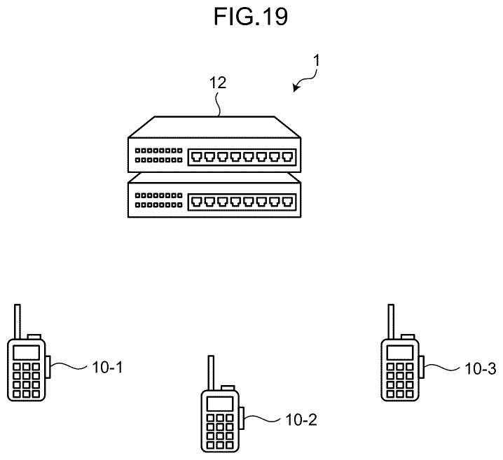

A communication failure according to the fifth embodiment will be described with reference to FIG. 19. FIG. 19 is a diagram for explaining a communication failure according to a fifth embodiment.

As illustrated in FIG. 19, it is assumed that the relay repeater 12 is transitioned from a normal mode in which communication is performed to a pause mode in which communication is not performed in the communication system 1. The pause mode is a state in which, for example, communication performed in the own system is temporarily stopped to cause a different system to use a communication band in order to effectively utilize a communication network. In this case, the communication between the communication terminal device 10-1 to the communication terminal device 10-3 and the relay repeater 12 enters a stopped state. As a result of this, the management device 16 is not able to manage the location information on the communication terminal device 10-1 to the communication terminal device 10-3 while the relay repeater 12 is in the pause mode in the communication system 1.

### Communication Method

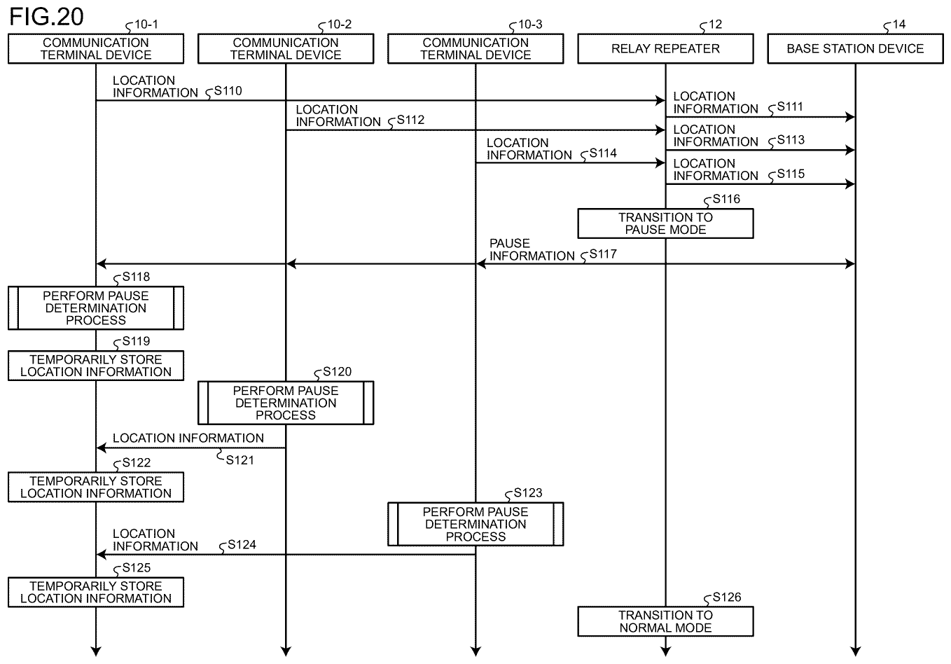

The communication method that is used in the communication system according to the fifth embodiment will be described with reference to FIG. 20. FIG. 20 is a sequence diagram illustrating a communication method that is used while a relay repeater included in a communication system according to the fifth embodiment is in a pause mode.

The processes to be performed at Step S110 to Step S115 are the same as those performed at Step S11 to Step S16, respectively, illustrated in FIG. 5, and therefore, descriptions thereof will be omitted.

The relay repeater 12 is transitioned from the normal mode to the pause mode (Step S116). When the relay repeater 12 is transitioned to the pause mode, the relay repeater 12 transmits the pause information that indicates that the relay repeater 12 has been transitioned to the pause mode to the communication terminal device 10-1, the communication terminal device 10-2, the communication terminal device 10-3, and the base station device 14 (Step S117).

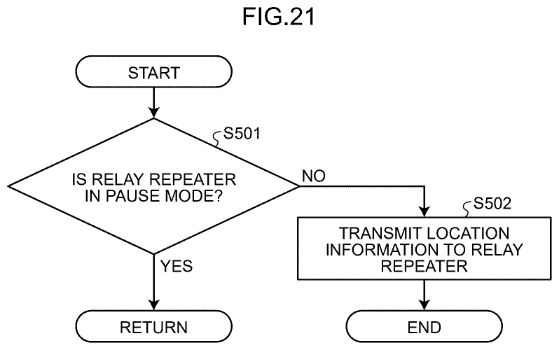

The control unit 34 included in the communication terminal device 10-1 performs a pause determination process on the relay repeater 12 (Step S118). FIG. 21 is a flowchart illustrating the pause determination process according to the fifth embodiment. The communication determination unit 44 included in the communication terminal device 10-1 determines whether or not the relay repeater 12 is in the pause mode (Step S501).

Specifically, after the communication determination unit 44 included in the communication terminal device 10-1 has received the pause information received from the relay repeater 12, the communication determination unit 44 included in the communication terminal device 10-1 determines that the relay repeater 12 is in the pause mode until the communication determination unit 44 receives the return information from the relay repeater 12. If it is determined that the relay repeater 12 is in the pause mode (Yes at Step S501), the process proceeds to Step S119. If it is not determined that the relay repeater 12 is in the pause mode (No at Step S501), the process proceeds to Step S502. If it is determined to be No at Step S501, the first communication control unit 40 included in the communication terminal device 10-1 causes the first communication unit 20 to transmit location information that has been detected by the location detection unit 48 and that indicates the current location to the relay repeater 12 by using the first communication technique (Step S502). And then, the first communication control unit 40 included in the communication terminal device 10-1 ends the process.

The processes to be performed at Step S119 is the same as the process performed at Step S19 illustrated in FIG. 5, and therefore, descriptions thereof will be omitted.

The processes to be performed at Step S120 is the same as the process performed at Step S118, and therefore, descriptions thereof will be omitted. However, if it is determined that the relay repeater 12 is in the pause mode (Yes at Step S501), the process proceeds to Step S121. The processes to be performed at Step S121 and Step S122 are the same as the processes performed at Step S21 and Step S22, respectively, illustrated in FIG. 5, and therefore, descriptions thereof will be omitted.

The processes to be performed at Step S123 is the same as the process performed at Step S118, and therefore, descriptions thereof will be omitted. If it is determined that the relay repeater 12 is in the pause mode (Yes at Step S501), the process proceeds to Step S124. The processes to be performed at Step S124 and Step S125 are the same as the processes performed at Step S24 and Step S25, respectively, illustrated in FIG. 5, and therefore, descriptions thereof will be omitted.

The relay repeater 12 ends the pause mode, and is transitioned to the normal mode (Step S126). And then, the relay repeater 12 ends the processes illustrated in FIG. 20.

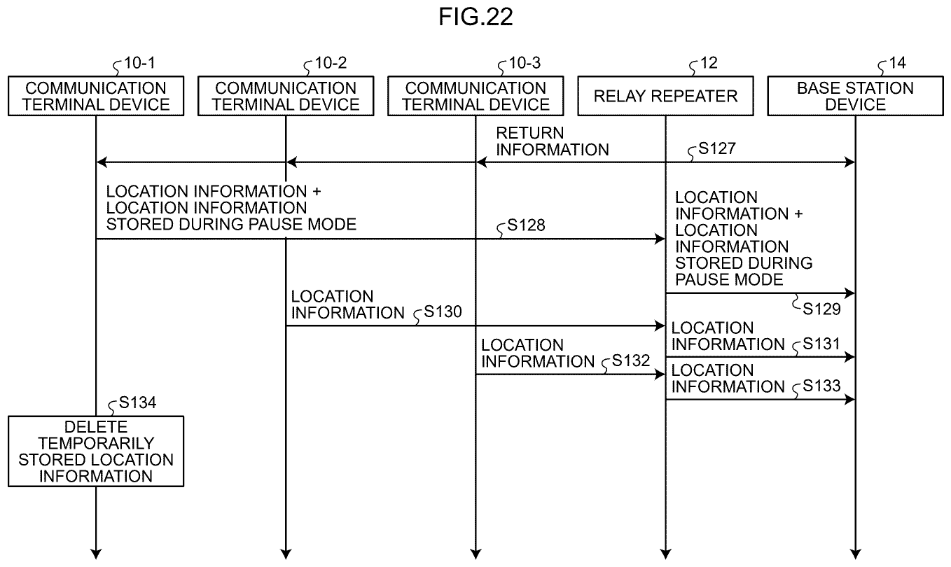

A communication method performed in the communication system according to the fifth embodiment will be described with reference to FIG. 22. FIG. 22 is a sequence diagram illustrating a communication method that is used after the relay repeater included in the communication system according to the fifth embodiment has been transitioned from the pause mode to a normal mode.

When the relay repeater 12 is transitioned from the pause mode to the normal mode, the relay repeater 12 transmits the return information that indicates the end of the pause mode to the communication terminal device 10-1, the communication terminal device 10-2, the communication terminal device 10-3, and the base station device 14 (Step S127).

When the first communication control unit 40 included in the communication terminal device 10-1 receives the return information from the relay repeater 12, the first communication control unit 40 included in the communication terminal device 10-1 causes the first communication unit 20 to aggregate the location information that has been detected by the location detection unit 48 and that indicates the current location and the location information that has been received from the communication terminal device 10-2 and the communication terminal device 10-3 during the pause mode of the relay repeater 12 and that has been stored in the storage unit 30, and to transmit the aggregated location information to the relay repeater 12 by using the first communication technique (Step S128).

The relay repeater 12 transmits the location information that has been received from the communication terminal device 10-1 and that indicates the current location of the communication terminal device 10-1 and the location information on the communication terminal device 10-1 to the communication terminal device 10-3 indicated in a time period during which the relay repeater 12 in a pause mode to the base station device 14 (Step S129).

The processes to be performed at Step S130 to Step S134 are the same as the processes performed at Step S30 to Step S34, respectively, illustrated in FIG. 7, and therefore, descriptions thereof will be omitted.

As described above, in the fifth embodiment, in a case where the relay repeater has been transitioned to a pause mode, the pieces of location information that are related to the respective communication terminal devices and that are indicated in a time period during which the relay repeater is in a pause mode are aggregated to the representative terminal. Then, in the fifth embodiment, after the relay repeater 12 has been transitioned to the normal mode, the representative terminal transmits the pieces of location information that are related to the respective communication terminal devices and that are indicated in a time period during which the relay repeater is in the pause mode to the relay repeater all at once. In other words, after the relay repeater 12 has been transitioned to the normal mode, the communication terminal devices other than the representative terminal do not transmit the location information that is not able to be transmitted to the relay device during the pause mode of the relay repeater. As a result of this, in the fifth embodiment, it is possible to prevent a strain of the communication line, such as an occurrence of congestion of the transmission signal generated as a result of each of the communication terminal devices attempting to retransmit the location information that is not able to be transmitted during the occurrence of the communication failure to the relay repeater all at once. In addition, it is possible to prevent the location information on each of the communication terminal devices from missing during the time period during which the relay repeater is in the pause mode.

Each of the components of the respective devices illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. Furthermore, the configurations constituted by separating or integrating the units may be dynamically performed.

According to the present disclosure, it is possible to appropriately transmit information generated in a time period during which wireless communication is not able to be performed to a base station device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication terminal device comprising:
a first communication unit that performs information communication with a management device by using a first communication technique;
a second communication unit that performs the information communication with another communication terminal device by using a second communication technique;
a communication determination unit that determines whether or not the information communication to be performed by the first communication unit is possible;
a role determination unit that determines whether or not a role of the own communication terminal device is a representative terminal;
a first communication control unit that controls the information communication performed by the first communication unit; and
a second communication control unit that controls the information communication performed by the second communication unit, wherein
the communication determination unit determines that the information communication is impossible in a case where the first communication unit receives pause information from the management device,
the communication determination unit determines that the information communication is possible in a case where the first communication unit receives return information after having received the pause information from the management device,
in a case where the communication determination unit determines that the information communication to be performed by the first communication unit is impossible, and also, in a case where the role determination unit determines that the own communication terminal device is not the representative terminal, the second communication control unit transmits information that is to be transmitted to the management device by using the first communication unit to the other communication terminal device by using the second communication unit,
in a case where the communication determination unit determines that the information communication to be performed by the first communication unit is impossible, and also, in a case where the role determination unit determines that the own communication terminal device is the representative terminal, the first communication control unit stores, in a storage unit, the information that is to be transmitted to the management device by the own communication terminal device by using the first communication unit and the information that has been received from the other communication terminal device by the second communication unit, and
in a case where the communication determination unit determines that the information communication to be performed by the first communication unit becomes possible, the first communication control unit transmits the information stored in the storage unit to the management device by using the first communication unit.

2. The communication terminal device according to claim 1, wherein
the first communication unit periodically receives a report signal, and
the communication determination unit determines that the information communication is possible in a case where the report signal is being received, and determines that the information communication is impossible in a case where the report signal is not received in a predetermined first time period or longer.

3. The communication terminal device according to claim 1, wherein
the first communication control unit transmits confirmation information to the management device by using the first communication unit, and receives a response to the transmitted confirmation information from the management device,
the communication determination unit determines that the information communication is possible in a case where the response is received from the management device, and
the communication determination unit determines that the information communication is impossible in a case where the response is not received from the management device in a predetermined second time period or longer.

4. The communication terminal device according to claim 1, wherein the communication determination unit generates a group of the communication terminal devices that are communicable by using the second communication unit, and determines that the communication terminal device that has a smallest number of an identifier for identifying the communication terminal devices included in the group as the representative terminal.

5. A wireless communication method comprising:
a step of performing information communication with a management device by a first communication unit using a first communication technique;
a step of performing the information communication with another communication terminal device by a second communication unit using a second communication technique;
a step of determining whether or not the information communication performed by the first communication unit is possible;
a step of determining whether or not a role of the own communication terminal device is a representative terminal;
a step of controlling the information communication performed by the first communication unit;
a step of controlling the information communication performed by the second communication unit;
a step of determining that the information communication is impossible in a case where the first communication unit receives pause information from the management device;
a step of determining that the information communication is possible in a case where the first communication unit receives return information after having received the pause information from the management device;
a step of transmitting information that is to be transmitted to the management device by using the first communication unit to the other communication terminal device by using the second communication unit, in a case it is determined that the information communication to be performed by the first communication unit is impossible, and also, it is determined that the own communication terminal device is not the representative terminal;
a step of storing, in a storage unit, the information that is to be transmitted to the management device by the own communication terminal device by using the first communication unit and the information that has been received from the other communication terminal device by the second communication unit in a case where it is determined that the information communication to be performed by the first communication unit is impossible, and also, in a case where it is determined that the own communication terminal device is the representative terminal; and
a step of transmitting the information stored in the storage unit to the management device by using the first communication unit in a case where it is determined that the information communication to be performed by the first communication unit becomes possible.
